(19) United States
(12) Patent Application Publication
(10) Pub. No.: US 2015/0326969 A1
(43) Pub. Date: Nov. 12, 2015

(54) MULTIMEDIA PLAYING SYSTEM AND SOUND CHANNEL CONTROL METHOD THEREOF

(71) Applicant: Acer Incorporated, New Taipei City (TW)

(72) Inventors: Po-Jen TU, New Taipei City (TW); Sheng-Yu WENG, New Taipei City (TW); Chiang-Tsun CHEN, New Taipei City (TW); Chun-Chieh CHIU, New Taipei City (TW); Chien-Hung LI, New Taipei City (TW); Iou-Ren SU, New Taipei City (TW); Neng-Wen YEH, New Taipei City (TW); Tzu-Hsiang CHANG, New Taipei City (TW)

(21) Appl. No.: 14/692,225

(22) Filed: Apr. 21, 2015

(30) Foreign Application Priority Data
May 6, 2014 (TW) 103116044

(51) Int. Cl. H04R 3/00

(52) U.S. Cl. CPC H04R 3/00; H04R 2420/07

(57) ABSTRACT

A multimedia playing system is provided. The multimedia playing system includes an earbud-type wireless earphone and a portable electronic device. The earbud-type wireless earphone includes a temperature sensor. The portable electronic device includes a dock port, a wireless module, an audio processor, and a controller. The wireless module receives temperature data from the temperature sensor of the earbud-type wireless earphone. The audio processor provides a first sound channel signal and a second sound channel signal. The controller provides one of the first sound channel signal and the second sound channel signal to the earbud-type wireless earphone according to the temperature data when the earbud-type wireless earphone is separated from the dock port.

### CROSS REFERENCE TO RELATED APPLICATIONS

This application claims priority of Taiwan Patent Application No. 103116044, filed on May 6, 2014, the entirety of which is incorporated by reference herein.

### BACKGROUND OF THE INVENTION

1. Field of the Invention

The invention relates to a multimedia playing system, and more particularly to a multimedia playing system capable of automatically selecting the sound channels.

2. Description of the Related Art

Nowadays, the sizes of portable electronic devices are getting smaller, and more and more functions can be provided. Because of their convenience, users prefer to use their portable electronic devices to listen to music and watch videos. In general, when playing multimedia applications, a user will use the built-in speaker of the portable electronic device or wear earphones to listen to the sound played by the applications.

Currently, in the design of earphone devices, the left and right sound channels are designed on the same device, in order to achieve a stereo effect. The user needs to identify which is the left/right sound channel earphone through the text (L/R) on the earphone devices, or by color.

Therefore, a multimedia playing system with an automatic channel selection function is desired, such that the user can directly wear the earphones without manually identifying the sound channels of the earphones.

### BRIEF SUMMARY OF THE INVENTION

Multimedia playing systems and sound channel control methods thereof are provided. An embodiment of a multimedia playing system is provided. The multimedia playing system comprises an earbud-type wireless earphone and a portable electronic device. The earbud-type wireless earphone comprises a temperature sensor. The portable electronic device comprises: a dock port; a first wireless module, receiving temperature data from the temperature sensor of the earbud-type wireless earphone; an audio processor, providing a first sound channel signal and a second sound channel signal; and, a controller. The controller provides one of the first sound channel signal and the second sound channel signal to the earbud-type wireless earphone according to the temperature data when the earbud-type wireless earphone is separated from the dock port.

Furthermore, another embodiment of a multimedia playing system is provided. The multimedia playing system comprises a first earbud-type wireless earphone, a second earbud-type wireless earphone, and a portable electronic device. The portable electronic device comprises a first wireless module, an audio processor, and a controller. The first wireless module establishes a wireless connection with the first earbud-type wireless earphone and the second earbud-type wireless earphone. The audio processor provides a first sound channel signal and a second sound channel signal. The controller obtains first temperature data of the first earbud-type wireless earphone and second temperature data of the second earbud-type wireless earphone via the first wireless module, and provides the first sound channel signal and the second sound channel signal to the first earbud-type wireless earphone and the second earbud-type wireless earphone via the first wireless module according to the first temperature data and the second temperature data.

Moreover, an embodiment of a sound channel control method for a multimedia playing system is provided, wherein the multimedia playing system comprises a portable electronic device and an earbud-type wireless earphone. Temperature data of the earbud-type wireless earphone is obtained via a first wireless module of the portable electronic device when detecting that the earbud-type wireless earphone has separated from a dock port of the portable electronic device. One of a left sound channel signal and a right sound channel signal is selectively transmitted to the earbud-type wireless earphone via the first wireless module of the portable electronic device according to the temperature data of the earbud-type wireless earphone.

Furthermore, another embodiment of a sound channel control method for a multimedia playing system is provided, wherein the multimedia playing system comprises a portable electronic device and an earbud-type wireless earphone. A specific sound channel signal of an application is provided to the earbud-type wireless earphone according to temperature data of the earbud-type wireless earphone, and a first speaker of the earbud-type wireless earphone is controlled to play the specific sound channel signal when detecting that a user wears the earbud-type wireless earphone. A left sound channel signal or a right sound channel signal of the application is selectively assigned as the specific sound channel signal according to the temperature data of the earbud-type wireless earphone. It is determined whether the application is a real-time application when detecting that the user pulls out the earbud-type wireless earphone according to the temperature data of the earbud-type wireless earphone. A second speaker of the portable electronic device is controlled to simultaneously play the left and right sound channel signals, and stopping providing the specific sound channel signal to the earbud-type wireless earphone when the application is the real-time application.

A detailed description is given in the following embodiments with reference to the accompanying drawings.

### BRIEF DESCRIPTION OF DRAWINGS

The invention can be more fully understood by reading the subsequent detailed description and examples with references made to the accompanying drawings, wherein:

FIG. 1 shows a multimedia playing system according to an embodiment of the invention;

FIG. 2 shows a block diagram of the multimedia playing system of FIG. 1;

FIG. 3A shows a rear view of the earphone of FIG. 1;

FIG. 3B shows a lateral view of the earphone of FIG. 1;

FIG. 3C shows another lateral view of the earphone of FIG. 1;

FIG. 4 shows a sound channel control method according to an embodiment of the invention; and

FIG. 5 shows a sound channel control method according to another embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

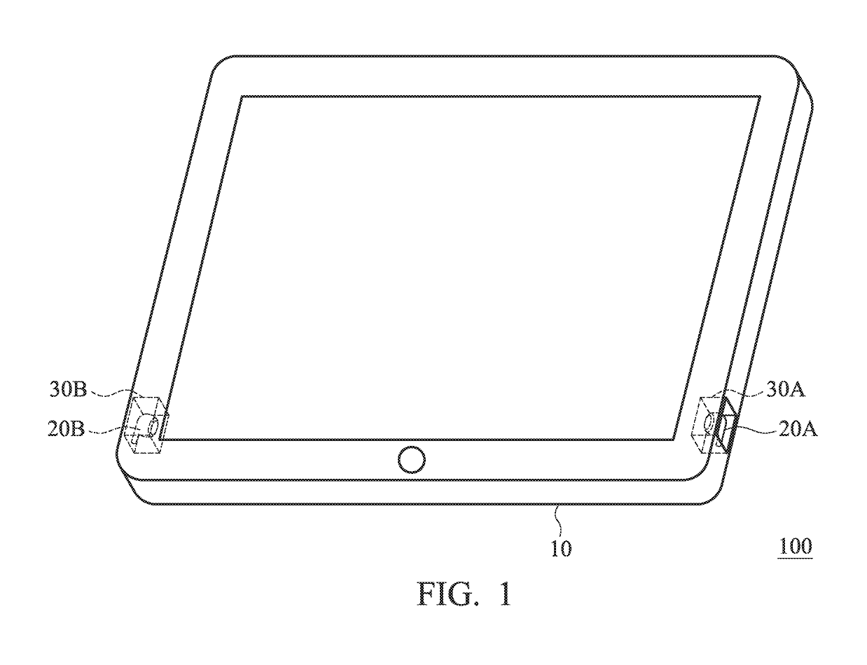

FIG. 1 shows a multimedia playing system 100 according to an embodiment of the invention. The multimedia playing system 100 comprises a portable electronic device 10 and a pair of earphones 20A and 20B, wherein the earphones 20A and 20B are earbud-type wireless earphones. The portable electronic device 10 has the dock ports 30A and 30B for connecting the earphones 20A and 20B, respectively. In the embodiment, the earphones 20A and 20B have the same circuits and the same shapes. In the embodiment, when any earbud-ear type wireless earphone connects to the dock port 30A/30B of the portable electronic device 10, the portable electronic device 10 can charge the connected earbud-ear type wireless earphone via the dock port 30A/30B. When the earbud-ear type wireless earphones 20A and 20B separate from the dock ports 30A and 30B, i.e. the user pulls out the earbud-ear type wireless earphones 20A and 20B from the dock ports 30A and 30B, the portable electronic device 10 can automatically provide a left sound channel signal and a right sound channel signal to the corresponding earphones 20A and 20B according to temperature data provided by the earphones 20A and 20B. In the embodiment, the portable electronic device 10 is a tablet PC, a notebook computer and so on.

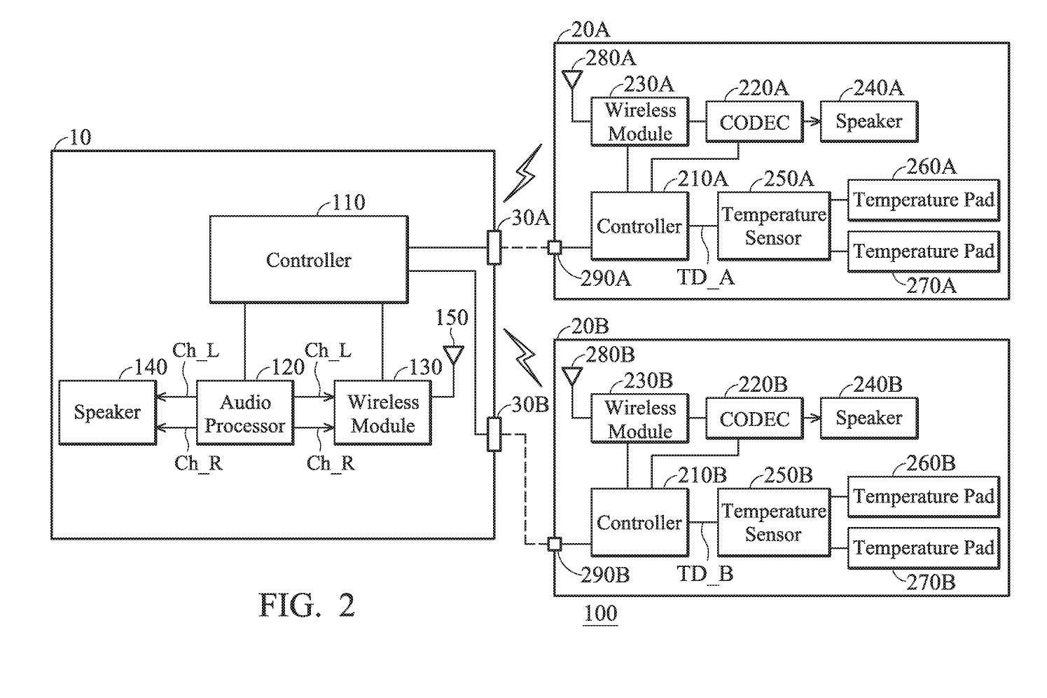

FIG. 2 shows a block diagram of the multimedia playing system 100 of FIG. 1. The multimedia playing system 100 comprises a portable electronic device 10 and two earbud-type wireless earphones 20A and 20B. The portable electronic device 10 comprises a controller 110, an audio processor 120, a wireless module 130, a speaker 140, an antenna 150 and a dock port 30A and a dock port 30B. The controller 110 is coupled to the dock port 30A and the dock port 30B, so as to detect whether an earbud-type wireless earphone is connected to or separated from the dock port 30A or the dock port 30B, and perform the subsequent operations. For example, if the controller 110 detects that the earphone 20A is separated from the dock port 30A (i.e. the earphone 20A is not coupled to the dock port 30A) or the earphone 20B is separated from the dock port 30B (i.e. the earphone 20B is not coupled to the dock port 30B), the controller 110 will link the separated earbud-type wireless earphone via the wireless module 130, to establish a wireless connection/communication. In FIG. 2, the earphone 20A comprises a controller 210A, a CODEC 220A, a wireless module 230A, a speaker 240A, a temperature sensor 250A, two temperature pads 260A and 270A, an antenna 280A and a connect port 290A, and the earphone 20B comprises a controller 210B, a CODEC 220B, a wireless module 230B, a speaker 240B, a temperature sensor 250B, two temperature pads 260B and 270B, an antenna 280B and a connect port 290B. Taking the earphone 20A as an example, when the earphone 20A is separated from the dock port 30A, the controller 210A of the earphone 20A will enable the wireless module 230A, so as to communicate with the wireless module 130 of the portable electronic device 10 via the antenna 280A. Furthermore, when the earphone 20A is separated from the dock port 30A, the controller 210A controls the temperature sensor 250A to continually monitor the temperatures of the temperature pads 260A and 270A and generate temperature data TD_A, and then the temperature data TD_A is provided to the portable electronic device 10 via the wireless module 230A. Next, in the portable electronic device 10, the controller 120 can determine that the earphone 20A is a left sound channel earphone or a right sound channel earphone according to the temperature data TD_A from the earphone 20A, i.e. the earphone 20A is worn in the user's left ear or right ear, so as to provide the corresponding sound channel signal to the earphone 20A. In FIG. 2, according to an application that is presently performing, the controller 110 controls the audio processor 120 to generate a left sound channel signal Ch_L and a right sound channel signal Ch_R, and transmits the left sound channel signal Ch_L and the right sound channel signal Ch_R to the wireless module 130. Therefore, when the earphone 20A is a left sound channel earphone, the portable electronic device 10 can provide the left sound channel signal Ch_L to the earphone 20A via the wireless module 130 and the antenna 150. Conversely, when the earphone 20A is a right sound channel earphone, the portable electronic device 10 can provide the right sound channel signal Ch_R to the earphone 20A via the wireless module 130 and the antenna 150.

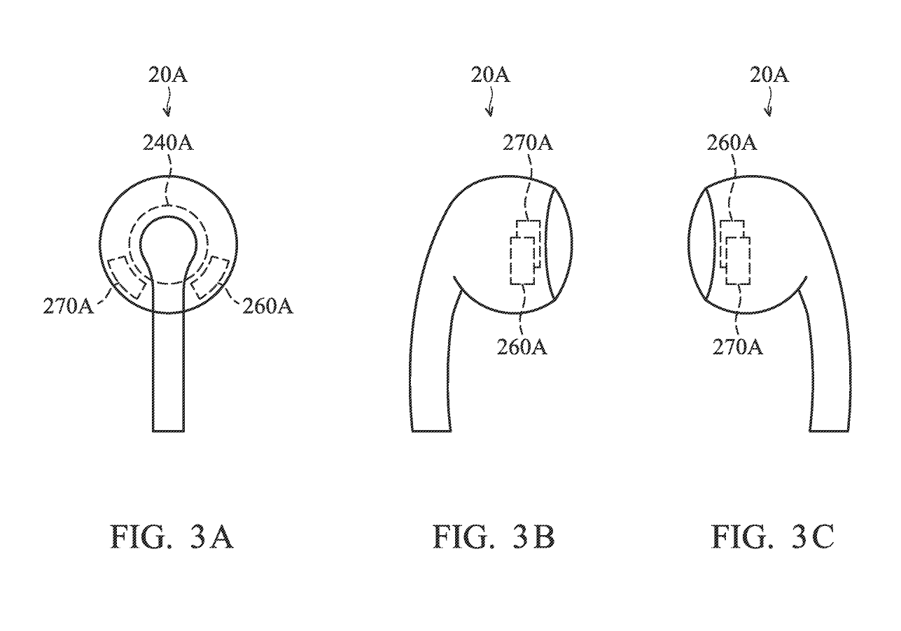

FIG. 3A shows a rear view of the earphone 20A of FIG. 1, and FIG. 3B and FIG. 3C show the different lateral views of the earphone 20A of FIG. 1. Referring to FIG. 2 and FIG. 3A together, in the earphone 20A, the speaker 240A is disposed between the temperature pad 260A and the temperature pad 270A, wherein the temperature pad 260A is disposed on right side of the back of the earphone 20A, and the temperature pad 270A is disposed on left side of the back of the earphone 20A. Therefore, when the user inserts the earphone 20A into his ear, the temperature sensor 250A can obtain the temperatures measured by the temperature pad 260A and the temperature pad 270A, respectively, and provide the temperature data TD_A to the controller 210A. Thus, the controller 210A can transmit the temperature data TD_A to the portable electronic device 10 via the wireless module 230A and the antenna 280A. Therefore, after receiving the temperature data TD_A, the portable electronic device 10 can determine that the earphone 20A is a left sound channel earphone or a right sound channel earphone according to the temperature data TD_A. For example, when the user inserts the earphone 20A into his left ear, as shown in FIG. 3B, the temperature pad 270A will come into contact with the tragus of the user, so the temperature of the temperature pad 270A is greater than that of the temperature pad 260A. Thus, in the portable electronic device 10, the controller 110 will determine that the earphone 20A is a left sound channel earphone according to the temperatures of the temperature pads 260A and 270A in the temperature data TD_A. Next, the controller 110 can control the wireless module 130 to transmit the left sound channel signal Ch_L to the earphone 20A. Conversely, when the user inserts the earphone 20A into his right ear, as shown in FIG. 3C, the temperature pad 260A will come into contact with the tragus of the user, so the temperature of the temperature pad 260A is greater than that of the temperature pad 270A. Thus, in the portable electronic device 10, the controller 110 will determine that the earphone 20A is a right sound channel earphone according to the temperatures of the temperature pads 260A and 270A in the temperature data TD_A. Next, the controller 110 can control the wireless module 130 to transmit the right sound channel signal Ch_R to the earphone 20A.

Referring back to FIG. 2, when the earphone 20A receives the data packet having the specific sound channel signal (Ch_R or Ch_L) via the antenna 280A and the wireless module 230A, the CODEC 220A converts the received data packet into the specific sound channel signal, and the speaker 240A will play the specific sound channel signal. Therefore, when the user pulls out the earphones 20A and 20B from the dock ports 30A and 30B and wears them on the ears, the controller 110 determines which one is a left sound channel earphone (i.e. worn on the left ear of user) and which one is a right sound channel earphone (i.e. worn on the right ear of user) according to the temperature data TD_A from the earphone 20A and the temperature data TD_B from the earphone 20B. Thus, the portable electronic device 10 can transmit the correct sound channel signal to the corresponding earphone. Moreover, in one embodiment, each earphone only has a temperature pad, for example, the earphone 20A only has the temperature pad 260A, and the earphone 20B only has the temperature pad 260B. In other words, in each earphone, the relative position between the temperature pad and the speaker is the same. Therefore, if only one earphone is pulled out from the portable electronic device 10, the portable electronic device 10 will provide a stereo signal formed by the left sound channel signal Ch_L and the right sound channel signal Ch_R to the earphone for playing the stereo signal until the other earphone is pulled out from the portable electronic device 10, and then the correct sound channel signals are transmitted to the corresponding earphones. For example, if the temperature of the temperature pad 260B of the earphone 20B exceeds that of the temperature pad 260A of the earphone 20A, the controller 110 can determine that the earphone 20B is a right sound channel earphone, and the earphone 20A is a left sound channel earphone. Conversely, if the temperature of the temperature pad 260A of the earphone 20A exceeds that of the temperature pad 260B of the earphone 20B, the controller 110 determines that the earphone 20A is a right sound channel earphone, and the earphone 20B is a left sound channel earphone.

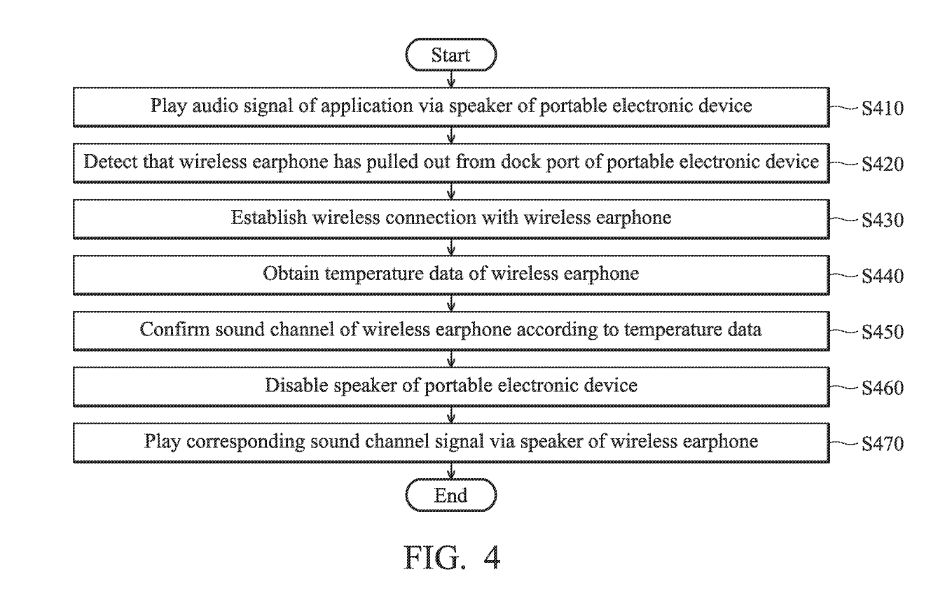

FIG. 4 shows a sound channel control method according to an embodiment of the invention. Referring to FIG. 2 and FIG. 4 together, first, in step S410, the portable electronic device 10 performs an application, and plays an audio signal of the application via the speaker 140, wherein the audio signal comprises the left sound channel signal Ch_L and the right sound channel signal Ch_R. Next, in step S420, the portable electronic device 10 detects that the earphone 20A or 20B has separated from the corresponding dock port. Next, the portable electronic device 10 establishes a wireless connection with the separated earphone 20A or 20B (step S430), and obtains the temperature data of the earphone (step S440). Next, in step S450, the portable electronic device 10 determines that the earphone is a left sound channel earphone or a right sound channel earphone according to the temperature data of the earphone. Next, the speaker 140 of the portable electronic device 10 is disabled (step S460). Next, the portable electronic device 10 provides the specific sound channel signal of the application corresponding to the earphone, to the earphone, so as to play the specific sound channel signal via the speaker of the earphone (step S470).

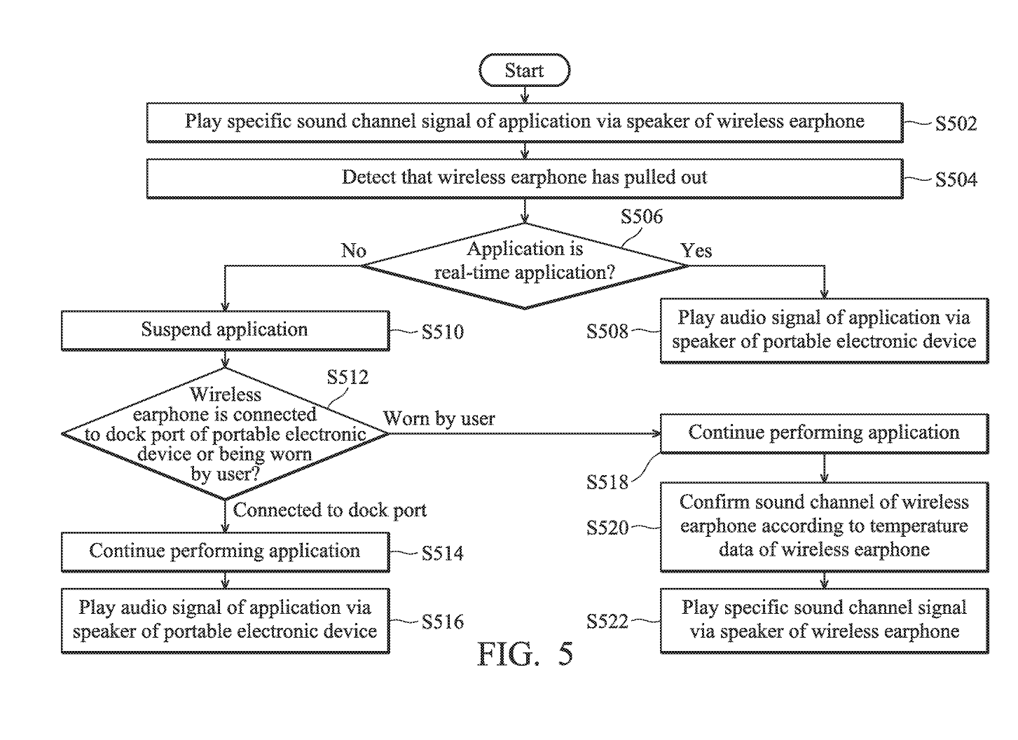

FIG. 5 shows a sound channel control method according to another embodiment of the invention. Referring to FIG. 2 and FIG. 5 together, first, the portable electronic device 10 has established a wireless connection with the earphone 20A or 20B that is worn by the user. In step S502, the portable electronic device 10 performs an application, and plays the specific sound channel signal of the application via the speaker of the earphone. Next, in step 504, the portable electronic device 10 detects that the user does not wear the earphone according to the temperature data of the earphone, i.e. the earphone has pulled out from the user's ear. Next, in step 506, the controller 110 of the portable electronic device 10 determines whether the application is a real-time application that cannot be interrupted. If the application is a real-time application, such as making a phone call, the audio signal of the application is played via the speaker 140 of the portable electronic device 10 (step S508). Conversely, if the application is a non-real-time application, such as playing a multimedia file, the portable electronic device 10 suspends the application (step S510). Next, in step S512, the portable electronic device 10 determines whether the earphone is connected to the dock port or is being worn by the user. If the controller 110 detects that the earphone is connected to the dock port 30A or 30B of the portable electronic device 10, the portable electronic device 10 continues performing the application (step S514), and plays the audio signal of the application via the speaker 140 (step S516). Conversely, if the controller 110 determines that the earphone is being worn by the user again according to the temperature data of the earphone, the portable electronic device 10 continues performing the application (step S518). Next, in step S520, the portable electronic device 10 re-determines that the earphone is a left sound channel earphone or a right sound channel earphone according to the temperature data of the earphone. Next, the portable electronic device 10 provides the specific sound channel signal of the application corresponding to the earphone to the earphone, so as to play the specific sound channel signal via the speaker of the earphone (step S522).

While the invention has been described by way of example and in terms of the preferred embodiments, it is to be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A multimedia playing system, comprising:
an earbud-type wireless earphone, comprising:
a temperature sensor; and
a portable electronic device, comprising:
a dock port;
a first wireless module, receiving temperature data from the temperature sensor of the earbud-type wireless earphone;
an audio processor, providing a first sound channel signal and a second sound channel signal; and
a controller, providing one of the first sound channel signal and the second sound channel signal to the earbud-type wireless earphone according to the temperature data when the earbud-type wireless earphone is separated from the dock port.

2. The multimedia playing system as claimed in claim 1, wherein the earbud-type wireless earphone comprises:
a first temperature pad coupled to the temperature sensor;
a second temperature pad coupled to the temperature sensor;
a speaker; and
a second wireless module, providing the temperature data to the portable electronic device, and providing the one of the first sound channel signal and the second sound channel signal from the portable electronic device to the speaker,
wherein the temperature data comprises a first temperature of the first temperature pad and a second temperature of the second temperature pad.

3. The multimedia playing system as claimed in claim 2, wherein in the earbud-type wireless earphone, the speaker is disposed between the first temperature pad and the second temperature pad.

4. The multimedia playing system as claimed in claim 3, wherein the controller of the portable electronic device provides the one of the first sound channel signal and the second sound channel signal to the earbud-type wireless earphone according to the first temperature of the first temperature pad and the second temperature of the second temperature pad.

5. The multimedia playing system as claimed in claim 3, wherein when the first temperature of the first temperature pad exceeds the second temperature of the second temperature pad, the controller of the portable electronic device provides the first sound channel signal to the earbud-type wireless earphone, and when the second temperature of the second temperature pad exceeds the first temperature of the first temperature pad, the controller of the portable electronic device provides the second sound channel signal to the earbud-type wireless earphone.

6. The multimedia playing system as claimed in claim 1, wherein the first sound channel signal is a left sound channel signal, and the second sound channel signal is a right sound channel signal.

7. A multimedia playing system, comprising:
a first earbud-type wireless earphone;
a second earbud-type wireless earphone; and
a portable electronic device, comprising:
a first wireless module, establishing a wireless connection with the first earbud-type wireless earphone and the second earbud-type wireless earphone;
an audio processor, providing a first sound channel signal and a second sound channel signal; and
a controller, obtaining first temperature data of the first earbud-type wireless earphone and second temperature data of the second earbud-type wireless earphone via the first wireless module, and providing the first sound channel signal and the second sound channel signal to the first earbud-type wireless earphone and the second earbud-type wireless earphone via the first wireless module according to the first temperature data and the second temperature data.

8. The multimedia playing system as claimed in claim 7, wherein each of the first and second the earbud-type wireless earphones comprises:
a temperature pad;
a temperature sensor coupled to the temperature pad, obtaining a temperature of the temperature pad;
a speaker; and
a second wireless module, providing the temperature of the temperature pad to the portable electronic device, and transmitting one of the first sound channel signal and the second sound channel signal from the portable electronic device to the speaker.

9. The multimedia playing system as claimed in claim 8, wherein a relative position between the temperature pad and the speaker in the first earbud-type wireless earphone is identical to a relative position between the temperature pad and the speaker in the second earbud-type wireless earphone.

10. The multimedia playing system as claimed in claim 9, wherein the controller of the portable electronic device provides the one of the first sound channel signal and the second sound channel signal to the first earbud-type wireless earphone, and provides the other of the first sound channel signal and the second sound channel signal to the second earbud-type wireless earphone according to the temperature of the temperature pad of the first earbud-type wireless earphone and the temperature of the temperature pad of the second earbud-type wireless earphone.

11. The multimedia playing system as claimed in claim 7, wherein the first sound channel signal is a left sound channel signal, and the second sound channel signal is a right sound channel signal.

12. A sound channel control method for a multimedia playing system, wherein the multimedia playing system comprises a portable electronic device and an earbud-type wireless earphone, the sound channel control method comprising:
obtaining temperature data of the earbud-type wireless earphone via a first wireless module of the portable electronic device when detecting that the earbud-type wireless earphone is separated from a dock port of the portable electronic device; and
selectively transmitting one of a left sound channel signal and a right sound channel signal to the earbud-type wireless earphone via the first wireless module of the portable electronic device according to the temperature data of the earbud-type wireless earphone.

13. The sound channel control method as claimed in claim 12, wherein the earbud-type wireless earphone comprises:
a temperature sensor;
a first temperature pad coupled to the temperature sensor;
a second temperature pad coupled to the temperature sensor;
a speaker; and
a second wireless module, providing the temperature data to the portable electronic device, and providing the one of the left sound channel signal and the right sound channel signal from the portable electronic device to the speaker,
wherein the temperature data comprises a first temperature of the first temperature pad and a second temperature of the second temperature pad.

14. The sound channel control method as claimed in claim 13, wherein in the earbud-type wireless earphone, the speaker is disposed between the first temperature pad and the second temperature pad.

15. The sound channel control method as claimed in claim 14, wherein the first temperature pad is disposed on the right side of the back of the earbud-type wireless earphone, and the second temperature pad is disposed on the left side of the back of the earbud-type wireless earphone,
wherein the step of selectively providing the one of the left sound channel signal and the right sound channel signal to the earbud-type wireless earphone via the first wireless module of the portable electronic device further comprises:
transmitting the right sound channel signal to the earbud-type wireless earphone when the temperature data indicates that the first temperature of the first temperature pad exceeds the second temperature of the second temperature pad; and
transmitting the left sound channel signal to the earbud-type wireless earphone when the temperature data indicates that the second temperature of the second temperature pad exceeds the first temperature of the first temperature pad.

16. The sound channel control method as claimed in claim 12, further comprising:
controlling a first speaker of the portable electronic device to play the left and right sound channel signals when detecting that the earbud-type wireless earphone connects to the dock port of the portable electronic device; and
controlling the first speaker of the portable electronic device to stop playing the left and right sound channel signals and controlling a second speaker of the earbud-type wireless earphone to play the one of the left sound channel signal and the right sound channel signal when the one of the left sound channel signal and the right sound channel signal is transmitted to the earbud-type wireless earphone.

17. A sound channel control method for a multimedia playing system, wherein the multimedia playing system comprises a portable electronic device and an earbud-type wireless earphone, the sound channel control method comprising:
according to temperature data of the earbud-type wireless earphone, providing a specific sound channel signal of an application to the earbud-type wireless earphone, and controlling a first speaker of the earbud-type wireless earphone to play the specific sound channel signal when detecting that a user wears the earbud-type wireless earphone;
selectively assigning a left sound channel signal or a right sound channel signal of the application as the specific sound channel signal according to the temperature data of the earbud-type wireless earphone;
determining whether the application is a real-time application when detecting that the user pulls out the earbud-type wireless earphone according to the temperature data of the earbud-type wireless earphone; and
controlling a second speaker of the portable electronic device to simultaneously play the left and right sound channel signals, and stopping providing the specific sound channel signal to the earbud-type wireless earphone when the application is the real-time application.

18. The sound channel control method as claimed in claim 17, further comprising:
suspending the application when the application is not the real-time application;
performing the suspended application, and controlling a second speaker of the portable electronic device to play the left and right sound channel signals when detecting that the earbud-type wireless earphone connects to a dock port of the portable electronic device; and
performing the suspended application, and re-assigning the left or right sound channel signal as the specific sound channel signal according to the temperature data of the earbud-type wireless earphone when detecting that the user wears the earbud-type wireless earphone.

19. The sound channel control method as claimed in claim 17, wherein the earbud-type wireless earphone further comprises:
a temperature sensor;
a first temperature pad coupled to the temperature sensor;
a second temperature pad coupled to the temperature sensor; and
a wireless module, providing the temperature data to the portable electronic device, and transmitting the specific sound channel signal from the portable electronic device to the speaker,
wherein the temperature data comprises a first temperature of the first temperature pad and a second temperature of the second temperature pad.

20. The sound channel control method as claimed in claim 19, wherein in the earbud-type wireless earphone, the speaker is disposed between the first temperature pad and the second temperature pad.
